(19) United States
(12) Patent Application Publication
(10) Pub. No.: US 2002/0131715 A1
(43) Pub. Date: Sep. 19, 2002

(54) Optical coupling

(75) Inventor: Dominic Joseph Brady, Oxford (GB)

Correspondence Address: FLESHNER & KIM, LLP, P.O. Box 221200, Chantilly, VA, 20153-1200, US

(73) Assignee: Bookham Technology Plc

(21) Appl. No.: 10/097,612

(22) Filed: Mar. 15, 2002

(30) Foreign Application Priority Data
Mar. 16, 2001 (GB) 0106745.3

(51) Int. Cl. G02B 6/26; G02B 6/30; G02B 6/255

(52) U.S. Cl. 385/51; 385/50; 385/49; 385/95

(57) ABSTRACT

An optical coupling between first and second optical components 1, 8 in which an input face 2A through which light is to pass of the first component 1 being directly bonded to an output face 8C through which light is to pass of the second component 8. Such a coupling may be provided, for example, between a rib waveguide 2 and an optical fibre 7.

### BACKGROUND OF THE INVENTION

This invention relates to an optical coupling between first and second components and to a method of forming the same.

Low loss couplings between optical components are required in many situations. A variety of techniques are used to couple, say, an optical fibre to another component, such as a waveguide, on an integrated optical device. The end of the fibre may be held in a fibre block and butted up against the end face of the waveguide at the edge of the integrated optical device. The end faces of the waveguide and fibre may be in contact or a small gap may be left therebetween. In the latter case, an index-matching compound may be provided in the gap to reduce back reflections at one or both of the end faces. The fibre block is typically secured to the edge of the integrated device by means of adhesive, e.g. an epoxy resin. However, the adhesive can penetrate into the gap between the end face of the fibre and the end face of the waveguide and this can adversely affect the optical coupling therebetween. Furthermore, a high temperature treatment is required to cure the adhesive which can lead to alignment drift between the components and hence optical losses. Such difficulties are particularly undesirable in telecommunication applications.

### SUMMARY OF THE INVENTION

The present invention seeks to provide an alternative way of optically coupling two optical components which helps avoid these problems.

According to a first aspect of the invention, there is provided a method of optically coupling first and second optical components comprising the steps of: preparing an output face through which light is to pass on the first component; preparing an input face through which light is to pass on the second component; contacting the prepared input and output faces and bonding them directly to each other.

According to a second aspect of the invention, there is provided, an optical coupling between first and second optical components, an input face through which light is to pass of the first component being directly bonded to an output face through which light is to pass of the second component.

According to another aspect of the invention there is provided an optical coupling between an optical component and a waveguide on an integrated optical device, a recess being formed in the device having a reflective facet for directing light between the optical component and the waveguide, the optical component being bonded directly to a major surface of the device.

Preferred and optional features of the invention will be apparent from the following description and from the subsidiary claims of the specification.

### BRIEF DESCRIPTION OF THE DRAWINGS

The invention will now be further described with reference to the accompanying drawings, in which:

FIG. 1 is a perspective view of a fibre block and waveguides on an integrated optical device, which are to be optically coupled according to a preferred embodiment of the present invention;

FIG. 2 is a cross-sectional view of part of the arrangement shown in FIG. 1 after the components have been bonded together; and

FIG. 3 is a cross-sectional view of a fibre block bonded to an integrated optical device according to another aspect of the invention.

### DETAILED DESCRIPTION OF PREFERRED EMBODIMENTS

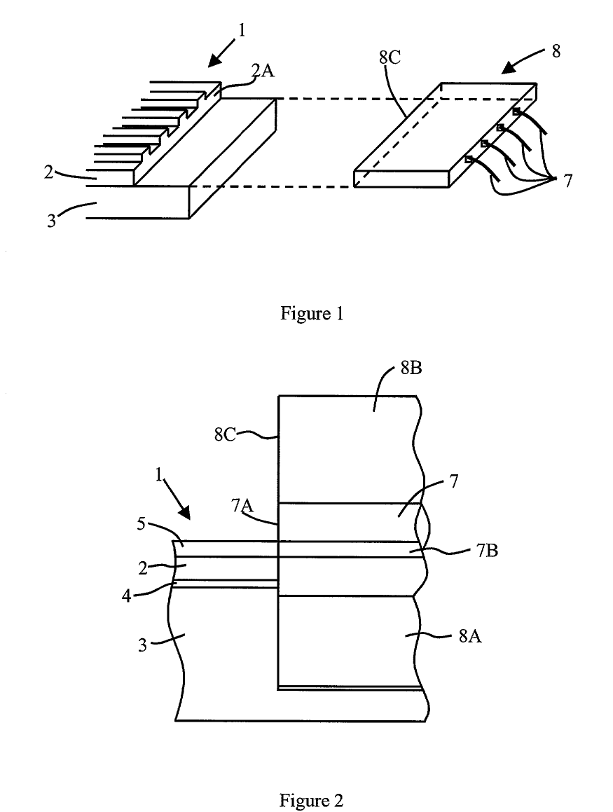

FIG. 1 shows an integrated optical device 1 formed on a wafer, e.g. a silicon-on-insulator wafer comprising a layer of silicon 2 separated from a substrate 3 (typically also of silicon) by an insulating layer 4, e.g. of silicon dioxide.

Rib waveguides 5 are formed in the silicon layer 2 and in this embodiment, terminate at a face 2A spaced from the edge of the wafer. The rib waveguides 5 are preferably provided with tapered portions (not shown) at the ends thereof, as described further in U.S. Pat. No. 6,108,478, and/or T-bars (not shown) at the ends thereof, as described further in WO99/66360.

FIG. 2 also shows optical fibres 7 mounted within a fibre block 8, which are to be coupled with the waveguides 5. The fibre block 8 may typically comprise a base portion 8A and a lid portion 8B each with V-grooves etched in the surface facing the other part. When the lid portion 8B is secured to the base portion 8A, the optical fibres 7 are held therein and aligned by the V-grooves in the lid and base portions. An output face 8C of the fibre block 8 and the end faces 7A of the optical fibres held therein are optically polished, e.g. using a lapping machine, whereby the final polishing for a scratch free surface is done using colloidal silica, such techniques being familiar to the person skilled in the art. Such a fibre block 8 may be similar to that used in conventional optical couplings.

As shown in FIG. 2, the fibre block is mounted on the device 1 so that its end face 8C is in contact with the end face 2A of the silicon layer 2. Location of the fibre block 8 on the device 1 may be used to align the two components in a direction perpendicular to the plane of the device 1. The fibre block 8 is then aligned laterally, i.e. within the plane of the device 1, by alignment means which will not be described herein as these are not relevant to the present invention, so that the core 7B of the fibre 7 is optically aligned with the rib waveguide 5. As will be described in more detail below, the end face 7A of the fibre is then bonded directly to the end face 2A of the silicon layer 2. Although, in FIG. 2, the end faces of the waveguides and the fibre block are shown to be perpendicular to the optical axes thereof, they are preferably inclined so that their normals are at a few degrees to their respective optical axes to reduce problems with back reflections therefrom.

Direct bonding is a technique whereby a low temperature permanent bond can be formed between two prepared surfaces. It relies on preparing of the mating surfaces to very high levels of flatness and smoothness. The two surfaces are then brought into contact with each other under pressure, whereby atomic forces create an initial bond between the surfaces. The strength of the bond can then be increased by annealing.

In the example given above, the end faces 2A and 7A are prepared to a high level of flatness and smoothness prior to being aligned with each other. The end face 7A of the fibre may be polished as described above. Optical fibres are typically formed of glass, e.g. silica, and polishing by standard lapping techniques, as described above, can achieve a very smooth finish, e.g. to within 10 nanometers or less. The end face 2A of the silicon layer may be formed by an etching process but this typically only achieves a smoothness in the region of 0.1 micron. The end face 2A is thus preferably prepared further to provide a terminating compound thereon which provides a surface of the required flatness and smoothness. First, the device 1 is cleaned and hydrophilized in an acid mixture (e.g. of sulphuric acid H₂SO₄ and hydrogen peroxide H₂O₂). The device is rinsed and spun-dried and then wetted with a silicate solution such as sodium silicate Na₂Si₃O₇ or Tetraethylorthosilicate (TEOS) Si(OC₂H₅)₄. The device is then rinsed and dried again.

This process forms a thin silica layer on the end face 2A of the silicon layer. It is then possible to re-flow the thin silica layer, e.g. by laser annealing, to leave it atomically smooth. The silica layer formed on the end face 2A of the silicon layer 2 typically has a thickness of 1 micron or less and preferably 0.05 microns or less. Such a thin layer of silica has a negligible effect upon the transmission of light through the end face 2A of the silicon layer 2.

The thin silica layer may also be formed on the end face of the silicon layer by thermal oxidation. Other compounds may also be used to provide an atomically smooth surface on the end face 2A, e.g. other glass materials or any other material which is optically conductive and which enables a sufficiently flat and smooth surface to be formed.

The fibre block 8 and the device are then joined together in a bond aligner with an accuracy of at least 0.5 microns, at room temperature. Pressure may be applied to the joint to assist in bonding if desired. The joined components are then annealed in a furnace at a temperature in the range 200-400° C. for two hours, preferably in an inert atmosphere or vacuum. This completes the bond between the two components so they are permanently bonded together. If required, the joint between the two components may be reinforced by adhesive around the edge of the bonded surfaces, or by other mechanical means. As the end faces have been bonded directly to each other, the adhesive is unable to penetrate therebetween so does not adversely affect the optical coupling between the two faces. The low temperature annealing step also avoids the problem of alignment drift compared to the prior art referred to above.

If higher annealing temperatures can be used without causing adverse effects on the device or alignment problems, the use of a terminating compound on the end face 2A of the silicon layer may not be necessary. However, in many applications, it will be desirable to keep the annealing temperature to less than 400° C. In these circumstances, the use of a terminating compound in the manner described above enables the direct bonding technique to be used.

A direct bonding technique is thus used to bond the output face of the optical fibre to the input face of the rib waveguide (or vice versa depending on the direction in which the light is travelling) so that in the finished product the light passes through the faces that have been bonded together. The direct bond provides a low loss coupling between the optical fibre and the rib waveguide and ensures that adhesive is kept away from the light path. Indeed, adhesive is excluded from the bonded joint between the components because the end faces are directly bonded to each other.

A similar technique can be used to bond the end face 8C of a fibre block 8 to the silicon layer at the edge of the chip, although means for aligning the two components in a direction perpendicular to the plane of the device 1 will then be required.

A single fibre, i.e. without a fibre block, can also be bonded to the end face of a rib waveguide in a similar manner. In this case, the end face of the fibre may be prepared to the required degree of flatness by a polishing technique such as high precision lapping, as described above. Alternatively, the fibre may be located in a V-groove and its end face bonded to the end face of a waveguide aligned with the end of the V-groove.

It will be appreciated that waveguides of other materials, e.g. InP, GaAs, may also be prepared and bonded together or to an optical fibre in the manner described above.

An optical fibre, whether mounted within a fibre block or not, may also be bonded directly to other optical components in a similar manner, e.g. to the output face of a light source such as a laser diode or the input face of a photodetector. Again, silicon dioxide or other reflowable material may be applied to the optical component to provide a flat surface to which the end of the fibre can be bonded.

In a further extension, the technique may be used to bond together the end faces of two rib waveguides, e.g. by bonding the edges of two chips directly to each other. The technique may also be used to bond together the end faces of two optical fibres, each of the end faces being polished and then direct bonded together as described above (as opposed to being joined by fusion bonding).

The above examples relate to situations in which the input and output faces to be bonded together are at the end of a waveguide or fibre, i.e. are perpendicular, or substantially perpendicular, to the optical axes thereof. However, the technique may also be used to bond together other types of components which are to be optically coupled, e.g. a wedge-shaped component to the upper face of a rib waveguide to form a tapered waveguide, e.g. of the form described in U.S. Pat. No. 6,108,478, or between two layers of an optical device. In this case the bonded faces lie substantially parallel to the plane of the device and substantially parallel to the optical axes of the individual components.

Other methods may be used to prepare the surfaces to be bonded together to the required level of flatness and smoothness to enable a direct bond to be formed therebetween, e.g. accurate polishing or dry etching techniques such as those described further in GB0105838.7 (Publication No______).

Another advantage of the method of coupling described above is that it can be carried out at wafer level, i.e. the processes described above can be carried out on a large number of devices on a wafer before the wafer is divided into individual chips.

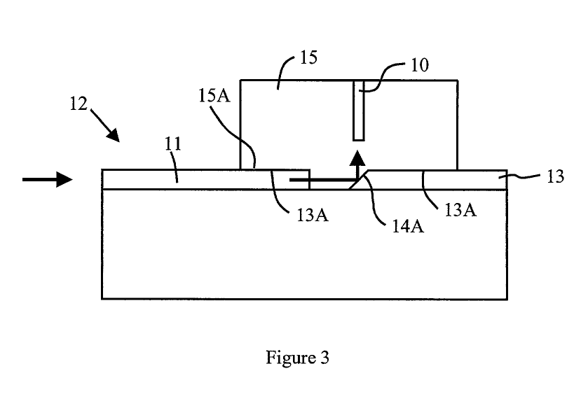

FIG. 3 shows another arrangement in which adhesive is kept away from the optical coupling between an optical fibre 10 and a waveguide 11 on an integrated device 12. The waveguide is preferably a rib waveguide formed in a silicon layer 13. In this case, a recess 14 is formed in the silicon layer 13 with a reflective facet 14A positioned to receive light from the waveguide 11 (or transmit light to the waveguide) and re-direct the light towards the optical fibre 10. If desired, a reflective coating, e.g. of aluminium, may be provided on the facet 14A. The optical fibre 10 is mounted within a fibre block 15, the end face 15A of which is bonded to an upper surface 13A of the silicon layer 13. The bond between the faces 15A and 13A may be formed in the same manner as that discussed above.

In this arrangement the optical axes of the optical fibre and integrated waveguide are approximately perpendicular to each other but it allows much larger areas of the faces 15A and 13A to be bonded together compared to the arrangement described above in which the fibre block is bonded to an end face of the silicon layer.

In another version of this arrangement, a light source, e.g. a laser diode, or light receiver, e.g. a photodiode may be bonded directly to the upper surface of the silicon layer 13 in place of the fibre block. Such an arrangement is similar to that described in U.S. Pat. No. 6,108,472 except that the optical component is bonded directly to the silicon layer 13 rather than being secured thereto by adhesive.

1. A method of optically coupling first and second optical components comprising the steps of:
preparing an output face through which light is to pass on the first component;
preparing an input face through which light is to pass on the second component;
contacting the prepared input and output faces and bonding them directly to each other.

2. A method as claimed in claim 1, in which the said faces are prepared so as to be atomically smooth and flat prior to bonding together.

3. A method as claimed in claim 1, in which at least one of the faces is prepared by forming a layer of a compound thereon which can be heated so that the compound flows to increase the flatness and smoothness of the face.

4. A method as claimed in claim 3 in which the compound is silicon dioxide.

5. A method as claimed in claim 1, in which pressure is applied to assist in bonding the said faces to each other.

6. A method as claimed in claim 1, in which an annealing step is employed to assist in bonding said faces together.

7. A method as claimed in claim 6, in which the annealing step is carried out at a temperature in the range of 200-400° C.

8. A method as claimed in claim 1, in which one of the optical components is an optical fibre.

9. A method as claimed in claim 1, in which one of the optical components comprises a waveguide on an integrated optical device.

10. A method as claimed in claim 9, in which the waveguide is a rib waveguide formed in a silicon layer.

11. A method as claimed in claim 8, in which the end of the fibre is mounted within a fibre block and an end face of the fibre block is bonded to an end face of the silicon layer.

12. An optical coupling between first and second optical components, an input face through which light is to pass of the first component being directly bonded to an output face through which light is to pass of the second component.

13. An optical coupling as claimed in claim 12 in which adhesive is excluded from the bond between the said faces.

14. An optical coupling as claimed in claim 12, having a layer of a terminating compound at the interface between the bonded faces, said layer being sufficiently thin so as to have no substantial effect upon light transmitted therethrough.

15. An optical coupling as claimed in claim 14, in which said layer has a thickness of 1.0 micron or less, and preferably 0.05 microns or less.

16. An optical coupling as claimed in claim 12, in which one of the components is an optical fibre.

17. An optical coupling as claimed in claim 12, which one of the components is a waveguide on an integrated optical device.

18. An optical coupling as claimed in claim 17 in which the waveguide is a rib waveguide formed in a silicon layer.

19. An optical coupling as claimed in claim 14, in which the terminating compound comprises a layer of silicon dioxide formed on a face of the silicon layer.

20. An optical coupling between an optical component and a waveguide on an integrated optical device, a recess being formed in the device having a reflective facet for directing light between the optical component and the waveguide, the optical component being bonded directly to a major surface of the device.

21. An optical coupling as claimed in claim 20, in which the optical component is an optical fibre mounted within a fibre block.

22. An optical component as claimed in claim 21, in which the optical axes of the waveguide and optical fibre are substantially perpendicular to each other.

23. A method of optically coupling first and second optical components substantially as hereinbefore described with reference to the accompanying drawings.
